(19) United States
(12) Patent Application Publication
(10) Pub. No.: US 2021/0356111 A1
(43) Pub. Date: Nov. 18, 2021

(54) OUTDOOR LED LIGHT

(71) Applicant: Green Inova Lighting Technology (Shenzhen) Limited, Shenzhen,Guangdong (CN)

(72) Inventors: Xiaofeng Zou, Bao'an District, Shenzhen, Guangdong (CN); Qiang Li, Bao'an District, Shenzhen, Guangdong (CN); Li Xu, Bao'an District, Shenzhen, Guangdong (CN); Guangyun Gu, Bao'an District, Shenzhen, Guangdong (CN); Rengui Zhou, Bao'an District, Shenzhen, Guangdong (CN)

(21) Appl. No.: 16/319,964

(22) PCT Filed: Dec. 10, 2018
(86) PCT No.: PCT/CN2018/120085

§ 371 Date: Jan. 23, 2019

(30) Foreign Application Priority Data
Oct. 31, 2018 (CN) 201811287292.6

(51) Int. Cl. F21V 29/80; F21V 31/00; F21V 5/04

(52) U.S. Cl. CPC F21V 29/80; F21Y 2115/10; F21V 5/04; F21V 31/005

(57) ABSTRACT

Disclosed is an outdoor LED light including a power supply compartment and a heat dissipation body which is connected at one side to the power supply compartment and sequentially provided at the other side with a PCB board on which at least one LED bread is arranged and a plurality of lenses, the heat dissipation body is arranged, on the one side facing the power supply compartment, with a plurality of needle-shaped heat dissipation columns

### FIELD

The present disclosure relates to the field of light technology, and more particularly, to an outdoor LED light.

### BACKGROUND

An outdoor LED light commonly used in the market generally adopts a blade-type heat dissipation structure with poor ventilation effect. In order to meet the heat dissipation demand, it is required that the radiator needs to be designed with large size. In addition, in order to enhance the luminous intensity of the light, more luminous areas need to be arranged, which also increases the size of the light.

### SUMMARY

In order to overcome the defects of the prior art, the present disclosure provides an outdoor LED light, which ensures good heat dissipation capability and luminous intensity without increasing an overall size of the light.

The technical solution used by the present disclosure to solve the technical problem thereof is that:

an outdoor LED light, comprising:

a power supply compartment, and

a heat dissipation body, which is connected at one side to the power supply compartment and sequentially provided at the other side with a PCB board and a plurality of lenses, the heat dissipation body being:
arranged, on the one side facing the power supply compartment, with a plurality of needle-shaped heat dissipation columns and a plurality of stud bolts,
provided with a heat dissipation through-hole at a middle of the heat dissipation body, rotatably and thermally connected to a mounting bracket,
provided with at least two lens panels on which the plurality of lenses are fixedly arranged, at least two LEDs being arranged on the PCB board within a coverage range of the lens panel,

provided with a shroud on a light emitting side of the outdoor LED light.

As a further improvement to the above solution, a portion of the plurality of needle-shaped heat dissipation columns gradually increase their heights in a radially outward direction from a center of the heat dissipation body, so that an curved surface structure is formed by each end of the portion of the plurality of needle-shaped heat dissipation columns facing away from the heat dissipation body.

As a further improvement to the above solution, the power supply compartment is provided, on one surface of the power supply compartment facing the heat dissipation body, with a convex surface protruding toward the heat dissipation body.

As a further improvement to the above solution, the other portion of the needle-shaped heat dissipation columns at the edge of the heat dissipation body gradually decrease their heights in a radially inward direction.

As a further improvement to the above solution, a diameter of the needle-shaped heat dissipation columns located at an outer periphery of the heat dissipation body is greater than a diameter of the needle-shaped heat dissipation columns located at an inner periphery of the heat dissipation body.

As a further improvement to the above solution, the heat dissipation through-hole is internally provided with a through-hole fastener, and the through-hole fastener is provided with an elastic reversed buckle.

As a further improvement to the above solution, the stud bolt respectively comprises a cylinder including a middle connecting hole along a length direction of the cylinder, a plurality of first reinforcing ribs extending around the cylinder.

As a further improvement to the above solution, the heat dissipation body is provided symmetrically, on the one side of the heat dissipation body facing the power supply compartment, with a pair of handles, which are fixedly arranged on the heat dissipation body through the stud bolt.

As a further improvement to the above solution, the mounting bracket is provided with a first axle hole and an arc-shaped chute arranged around the first axle hole; the heat dissipation body is provided with a mounting wall for connecting the mounting bracket, the mounting wall is provided with a second axle hole coaxial with the first axle hole and a threaded hole with an axis passing through the arc-shaped chute; the first axle hole and the second axle hole are connected through a bolt, a bolt passing through the arc-shaped chute is arranged in the threaded hole.

As a further improvement to the above solution, a plurality of said threaded holes are arranged evenly on a circumference taking the first axle hole as a center of the circle.

As a further improvement to the above solution, the mounting wall is provided, on a back surface of the mounting wall, with a plurality of second reinforcing ribs.

As a further improvement to the above solution, the mounting bracket is provided with a plurality of ventilation holes.

As a further improvement to the above solution, the at least two lens panels respectively have a fan-shaped structure and circumferentially arranged to form a circular structure.

As a further improvement to the above solution, the heat dissipation body is provided with a waterproof concave cavity at a position of the heat dissipation body corresponding to the lens panel, and the lens panel is embedded in the waterproof concave cavity.

As a further improvement to the above solution, the lens panel is provided at an edge with a first waterproof groove, and waterproof sealing is formed between the lens panel and the heat dissipation body through a first waterproof ring embedded in the first waterproof groove.

As a further improvement to the above solution, the power supply compartment comprises:

a top shell provided with a second waterproof groove and a waterproof retaining edge,

a bottom shell, and

a second waterproof ring arranged between the top shell and the bottom shell, the second waterproof ring comprising an extending portion, and a first bonding portion and a second bonding portion located on both sides of the extending portion,

wherein, during mounting, the extending portion is embedded in the second waterproof groove, the first bonding portion and the second bonding portion are attached to an inner wall of the top shell, and the waterproof retaining edge is respectively attached to a side surface of the second bonding portion and the bottom shell.

As a further improvement to the above solution, the power supply compartment is provided, on a side surface and a surface of the power supply compartment facing far away from the heat dissipation body, with a plurality of heat dissipation fins in divergent arrangement.

As a further improvement to the above solution, the heat dissipation body is provided with a ring-shape pressing plate, the heat dissipation body is provided on a side surface with a concave shoulder, the ring-shape pressing plate is provided at one end with an inwardly extended supporting wall, the ring-shape pressing plate is sleeved on the heat dissipation body, and the supporting wall is attached to the concave shoulder and is thermally connected to the heat dissipation body.

The present disclosure has the beneficial effect as follow.

According to the outdoor LED light of the present disclosure, the plurality of needle-shaped heat dissipation columns are arranged on one side of the heat dissipation body facing the power supply compartment, therefore, the needle-shaped heat dissipation column has better heat dissipation capacity and significantly increases the heat dissipation area of the light compared with a traditional blade-type heat dissipation structure. And within a coverage range of the lens panel, at least two LEDs are arranged on the PCB board, so that the luminous intensity of the light is enhanced without increasing the size of the light. The outdoor LED light of the disclosure ensures good heat dissipation effect and luminous intensity without increasing the size of the light.

### BRIEF DESCRIPTION OF THE DRAWINGS

The present disclosure is further described hereinafter with reference to the drawings and the embodiments.

FIG. 1 is an overall structure diagram of an embodiment of an outdoor LED light according to the present disclosure;

FIG. 2 is a structure diagram of the outdoor LED light after a lens panel is removed according to the present disclosure;

FIG. 3 is a structure diagram of the lens panel;

FIG. 4 is a side view of FIG. 1;

FIG. 5 is a top view of FIG. 1;

FIG. 6 is a structure diagram of the outdoor LED light after a handle is removed according to the present disclosure;

FIG. 7 is a partially enlarged structure diagram of part A in FIG. 6;

FIG. 8 is a partially exploded structure diagram of the outdoor LED light according to the present disclosure;

FIG. 9 is a partially enlarged structure diagram of part B in FIG. 8;

FIG. 10 is a structure diagram of an embodiment of a through-hole fastener according to the present disclosure;

FIG. 11 is a structure diagram of another embodiment of the through-hole fastener according to the present disclosure;

FIG. 12 is an exploded structure diagram of a power supply compartment;

FIG. 13 is a structure diagram of a top shell; and

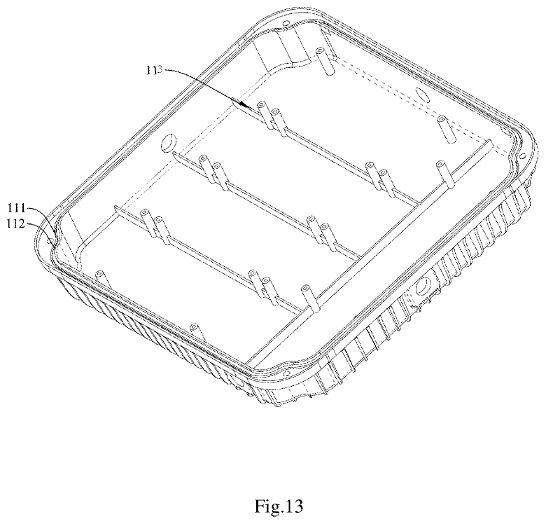

FIG. 14 is a structure diagram of a bottom shell

### DETAILED DESCRIPTION OF THE EMBODIMENTS

The concepts, specific structures and technical effects of the disclosure will be clearly and completely described below by embodiments with reference to the accompanying drawings in order to fully understand the objectives, solutions and effects of the disclosure. It is to be noted that, the embodiments in the present application and the features in the embodiments can be combined if not conflicted.

It is to be noted that, unless otherwise specified, when a certain feature is regarded as being “fixed” or “connected” to another feature, this feature may be fixed or connected to the another feature either directly or indirectly. In addition, the expressions such as upper, lower, left and right used in the disclosure are merely provided with respect to the positional relationship between components in the accompanying drawings of the disclosure.

In addition, unless otherwise defined, the technical and scientific terms used herein have meanings the same as the common meanings interpreted by those skilled in the art. The terms used herein are merely for describing the specific embodiments, rather than limiting the disclosure. The term “and/or” used herein includes any combination of one or more of related listed items.

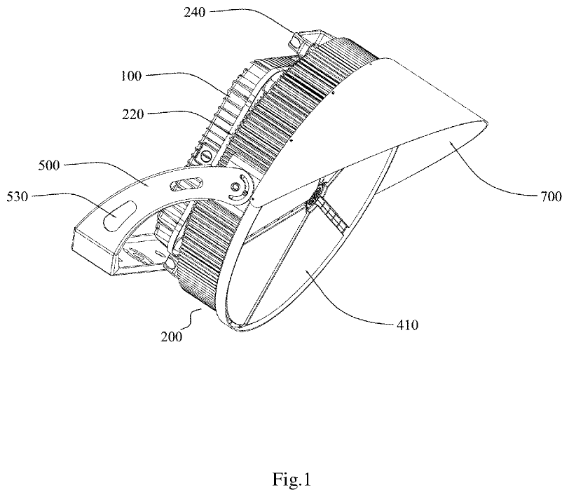

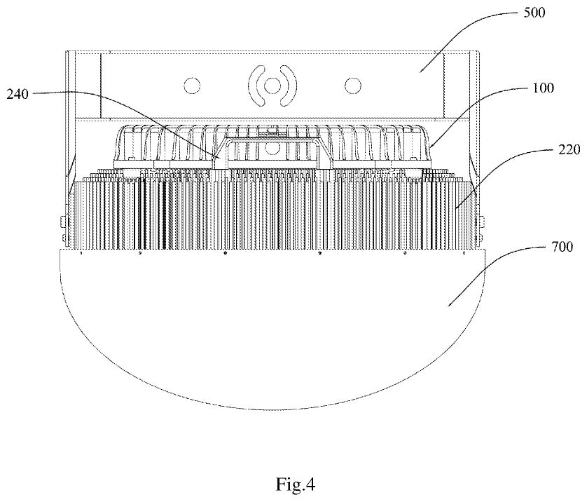

With reference to FIG. 1 to FIG. 4, the present disclosure provides an outdoor LED light, which includes a power supply compartment 100, a heat dissipation body 200, a PCB board 300 and a plurality of lenses 400 arranged sequentially. The heat dissipation body 200 is connected to the power supply compartment 100 at one side, and is sequentially provided with the PCB board 300 and the plurality of lenses 400 at the other side. The PCB board 300 is provided with a plurality of LEDs 310 for generating light that is emitted to the outside through the lens 400. In the embodiment, a plurality of needle-shaped heat dissipation columns 220 are arranged on a surface of the heat dissipation body 200 facing the power supply compartment 100, and a heat dissipation area of the heat dissipation body 200 is significantly increased by using the needle-shaped heat dissipation columns 220, thereby increasing the heat dissipation capacity of the light.

The plurality of lenses 400 are mounted, and preferably integrally, on a lens panel 410. In an embodiment of the present disclosure, the lens panel 410 may be of a circle shape to be mounted on the heat dissipation body 200. In an alternative and preferable embodiment of the present disclosure, the lens panel 410 may be of a fan shape, and at least two lens panels 410 are sequentially spliced along a circumferential direction to form a circular structure, so as to be mounted on the heat dissipation body 200.

In order to increase the luminous intensity of the light, at least two LEDs 310 are arranged on the PCB board 300 within an area defined by each lens panel 410.

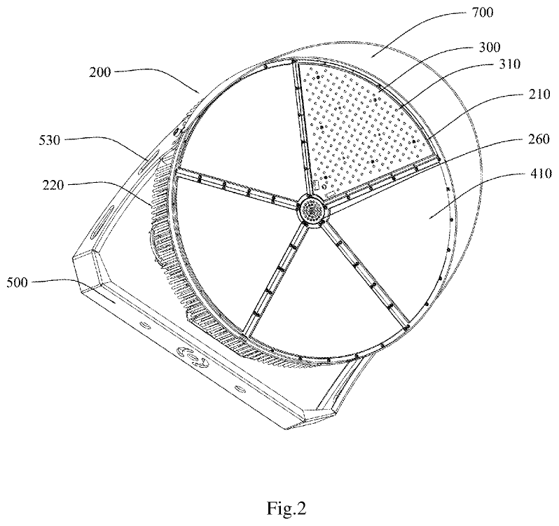

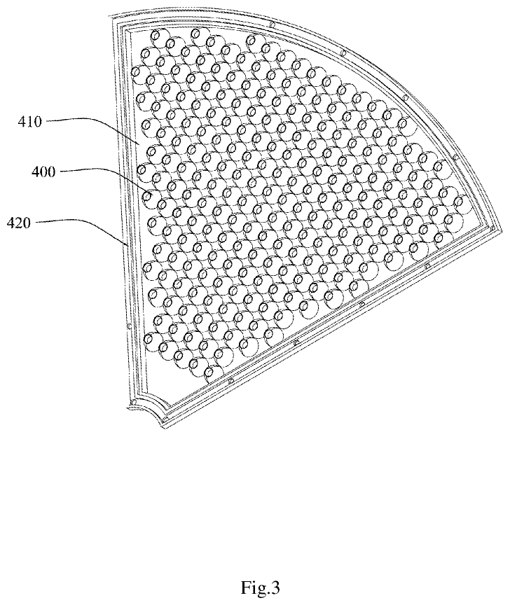

As shown in FIG. 2 and FIG. 3, the heat dissipation body 200 is provided with a waterproof cavity 210 for mounting the lens panel 410, the waterproof cavity 210 has a fan-shaped structure matching a shape of the lens panel 410, the lens panel 410 is embedded in the waterproof cavity 210 with a periphery of the lens panel 410 fitted with that of the waterproof cavity 210. The lens panel 410 is further provided at an edge thereof with a first waterproof groove 420 within which a first waterproof ring (not shown in the drawings) is embedded. The first waterproof ring is made of flexible material, and when the lens panel 410 is mounted, the first waterproof ring is deformed by a pressing force due to the mounting of the lens panel 410 and fills a gap between the lens panel 410 and the heat dissipation body 200, thereby improving a waterproof level there.

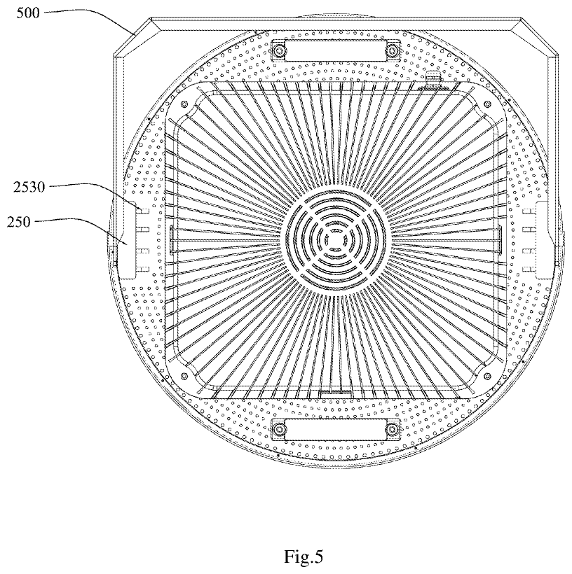

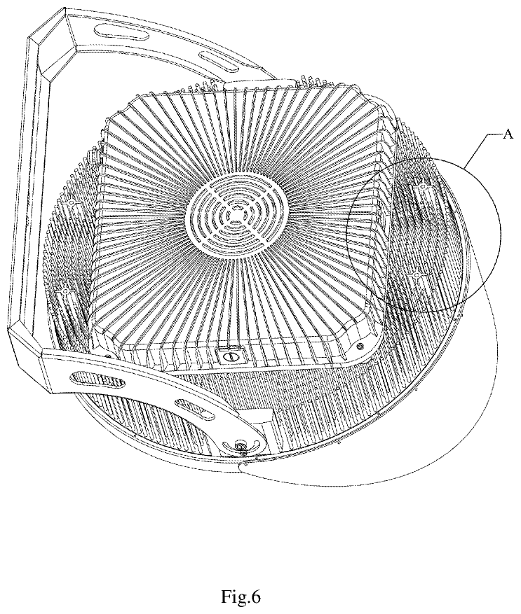

The plurality of needle-shaped heat dissipation columns 220 are distributed on an entire surface of the heat dissipation body 200 facing the power supply body 100. In the embodiment, the distribution is preferably in a form of a plurality of outwardly diffused circles. As shown in FIG. 5 and FIG. 6, a height of the needle-shaped heat-dissipating column 220 located at the edge of the heat-dissipating body 200 is decreased to create a thin and light feeling as a whole, and a diameter of the needle-shaped heat-dissipating column 220 at that location is increased to enhance the strength thereof, which is conductive to reducing impact damage during transportation and mounting process.

From a circle center of the heat dissipation body 200, the height of the needle-shaped heat dissipation columns 220 gradually increase in a radially outward direction to form an curved surface structure, so as to form a rapid heat dissipation channel between the curved surface structure and a bottom surface of the power supply compartment 100, thereby accelerating the movement of heat from the middle to both sides and improving the heat dissipation efficiency.

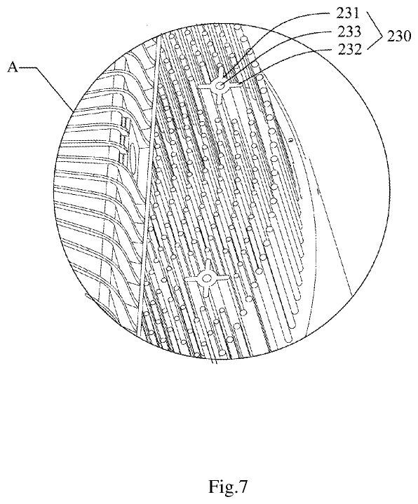

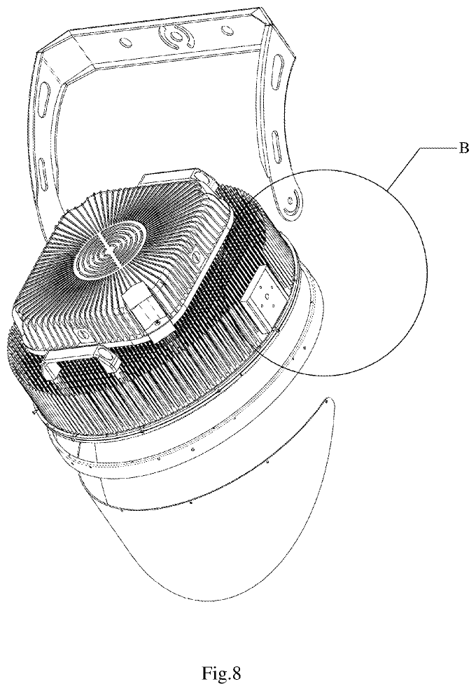

As shown in FIG. 7 and FIG. 8, the heat dissipation body 200 is further provided, on a surface of the heat dissipation body 200 facing the power supply compartment 100, with a plurality of stud bolts 230 parallel to the needle-shaped heat dissipation columns 220 for connection of the heat dissipation body 200 with the power supply compartment 100 and for mounting a component on the heat dissipation body 200. The stud bolt 230 includes a cylinder 231 and first reinforcing ribs 232 respectively extending outward from a side surface of the cylinder 231 to enhance the strength of the cylinder 231, and the cylinder 231 is provided with a middle connecting hole 233 along a length direction of the cylinder 231.

As shown in FIG. 5, the heat dissipation body 200 is connected to a pair of handles 240 through the stud bolt 230, and the pair of handles 240 are symmetrically arranged on two sides of the power supply compartment 100.

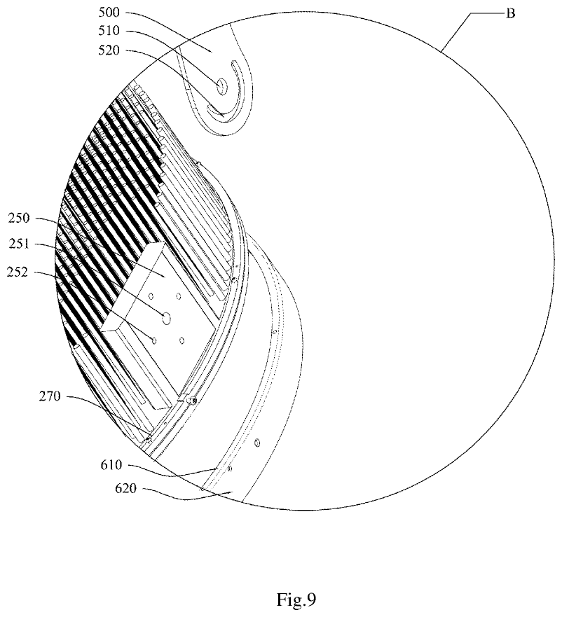

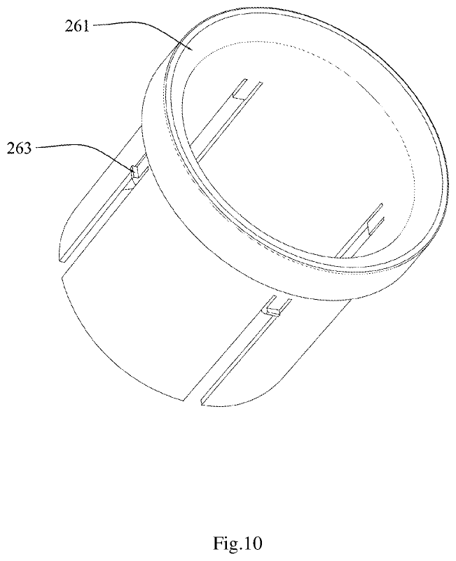

As shown in FIG. 9 and FIG. 10, the heat dissipation body 200 is further provided with a pair of mounting walls 250 symmetrically arranged on the other two sides of the power supply compartment 100. The heat dissipation body 200 is connected to a mounting bracket 500 through the pair of mounting walls 250, the mounting bracket 500 is provided with a first axle hole 510 and an arc-shaped chute 520 arranged around the first axle hole 510, the mounting wall 250 is provided with a second axle hole 251 coaxial with the first axle hole 510, the mounting wall 250 is further provided with threaded holes 252 around the second axle hole 251, the first axle hole 510 and the second axle hole 251 are connected through a bolt during mounting, so that the first axle hole 510 and the second axle hole 251 may rotate with each other, and each of the threaded holes 252 and the arc-shaped chute 520 may be connected through a bolt, so that the bolt is fixed to the threaded hole 252 and may slide along a path of the arc-shaped chute 520, thereby guiding and limiting the movement of the mounting bracket 500. Preferably, four threaded holes 252 are circumferentially and evenly arranged on the mounting wall 250 to meet different mounting conditions of the mounting bracket 500.

As shown in FIG. 6, in the embodiment, an inner wall of the mounting wall 250 is provided with second reinforcing ribs 2530; the mounting bracket 500 is in contact with the mounting wall 250 to increase the heat dissipation efficiency of the heat dissipation body 200 through the mounting bracket 500, and the mounting bracket 500 is provided with a plurality of ventilation holes 530 to assist in enhancing the heat dissipation effect.

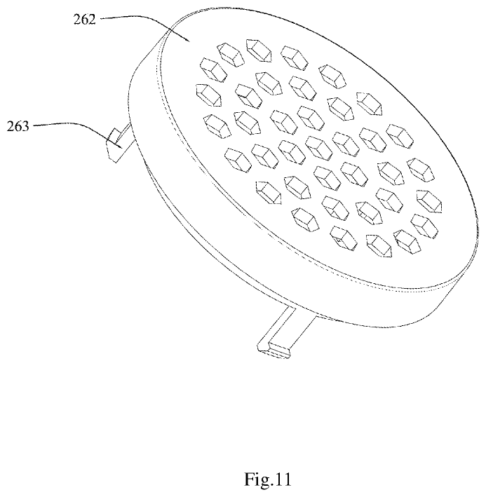

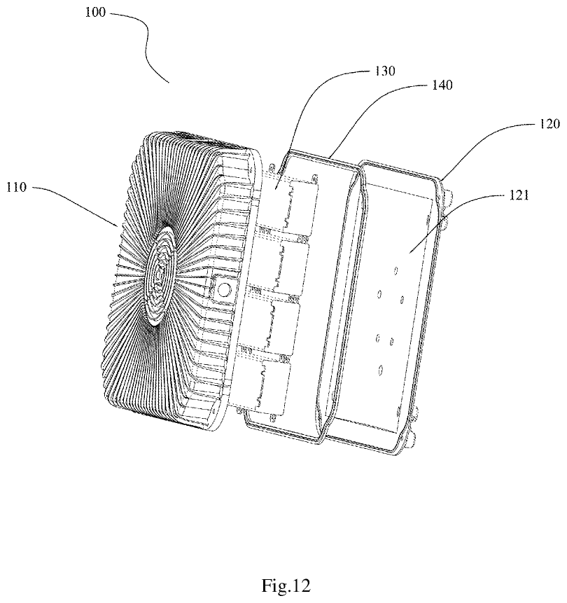

As shown in FIG. 2, FIG. 11 and FIG. 12, the heat dissipation body 200 is provided with a heat dissipation through hole at a middle of the heat dissipation body 200 to ensure air convection at both sides of the heat dissipation body 200. For overall beauty, the heat dissipation through-hole is internally provided with a through-hole fastener 260. In the embodiment, the through-hole fastener 260 is a decorative ring 261 or a decorative net 262, which are mounted alternatively, the decorative ring 261 is provided with a larger through-hole at a middle thereof, the decorative net 262 is provided with a plurality of small through-holes in a net shape at a middle thereof, and the decorative ring 261 and the decorative net 262 are both provided with elastic reversed buckles 263 at a back surface for mounting on the heat dissipation body 200.

As shown in FIG. 9 and FIG. 10, the heat dissipation body 200 is provided, on a peripheral surface, with a concave shoulder 270 by means of which the heat dissipation body 200 is mounted with a ring-shape pressing plate 600, the ring-shape pressing plate 600 is provided with a supporting wall 610 protruding toward the inside thereof, and has an inner diameter larger than a diameter of the heat dissipation body 200. During mounting, the ring-shape pressing plate 600 is sleeved from a back surface of the heat dissipation body 200, until the supporting wall 610 is fitted with the concave shoulder 270. It is noted that in the embodiment, the supporting wall 610 is fitted with the concave shoulder 270 for thermal connection, and the heat dissipation efficiency of the heat dissipation body 200 is increased by using the thermal connection between the ring-shape pressing plate 600 and the heat dissipation body 200.

The heat dissipation body 200 is further provided, on an emitting surface, with a shroud 700 which is fixedly arranged on an outer surface of the ring-shape pressing plate 600. A cylindrical surface structure in which an area of the shroud 700 gradually decreases is formed in a light emitting direction.

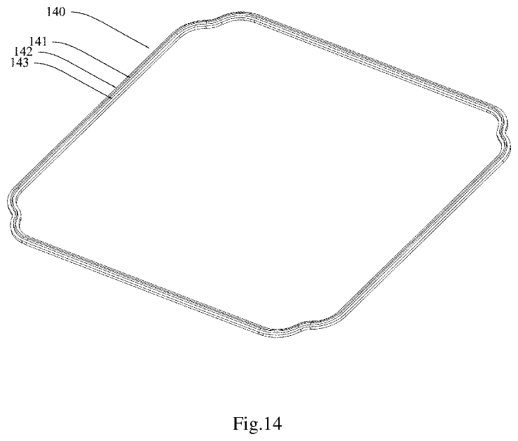

As shown in FIG. 12 and FIG. 14, the power supply compartment 100 includes a top shell 110 and a bottom shell 120 connected mutually, and a power supply 130 located in a space formed by the top shell 110 and the bottom shell 120. A second waterproof ring 140 is further arranged between the top shell 110 and the bottom shell 120 to ensure the waterproof performance of the connection thereof, the second waterproof ring 140 includes an extending portion 141, and a first fitting portion 142 and a second fitting portion 143 located on both sides of the extending portion 141. The top shell 110 is provided with a second waterproof groove 111 into which the extending portion 141 is embedded and a waterproof retaining edge 112 towards an inside of the second waterproof groove 111. During mounting, a bottom surface of the second waterproof ring 140 is mounted on the bottom shell 120, the extending portion 141 is embedded in the second waterproof groove 111, the first bonding portion 142 and the second bonding portion 143 are attached to a bottom surface of the top shell 110, the waterproof retaining edge 112 is respectively attached with a top surface of the bottom shell 120 and a side surface of the second bonding portion 143. The second waterproof ring 140 is made of flexible material, and by being subjected to a pressing force during a mounting process, the second waterproof ring may be deformed and fill a gap between the top shell 110 and the bottom shell 120, thereby ensuring the waterproof performance between the top shell 110 and the bottom shell 120.

The bottom shell 120 is provided, on the bottom surface, with a convex surface 121 protruding toward the heat dissipation body 200, the convex surface 121 has a certain distance from the curved surface structure formed by the plurality of needle-shaped heat dissipation columns 210. The structure of the convex surface 121 increases the heat dissipation efficiency of the power supply compartment 100, and at the same time, the convex surface 121 enables a stronger structure strength for the power supply compartment 100 than a conventional planar structure.

The power supply 130 is mounted on the bottom shell 120, the top shell 110 is further provided on an inner wall thereof with a plurality of retaining edges 113, the retaining edge 113 plays a role in positioning the power supply 130, and the power supply 130 is arranged in a space enclosed by the plurality of retaining edges 113.

Preferably, the power supply compartment 100 are further provided, on both a top surface and a side surface thereof, with a heat dissipation fin 140 that diverges outwardly to enhance the overall heat dissipation efficiency of the light.

As shown in FIG. 12, the connecting column 122 is provided, on a surface facing the heat dissipation body 200, with a screw hole, and the bottom shell 120 is fixedly connected to the top shell 110 and the heat dissipation body 200 through the connecting column 122. In the embodiment, the connecting column 122 has a cone frustum structure, so as to maintain a sufficient heat dissipation distance between the bottom shell 120 and the heat dissipation body 200 when the bottom shell 120 is connected to the heat dissipation body 200.

Although the preferred embodiments of the disclosure have been specifically described above, the disclosure is not limited thereto. Those skilled in the art can make various equivalent transformations or replacements without departing from the principle of the disclosure, and these equivalent transformations or replacements shall fall into the scope defined by the appended claims of the disclosure.

1. An outdoor LED light, comprising:
a power supply compartment, and
a heat dissipation body, which is connected at one side to the power supply compartment and sequentially provided at the other side with a PCB board and a plurality of lenses, the heat dissipation body being:
arranged, on the one side facing the power supply compartment, with a plurality of needle-shaped heat dissipation columns and a plurality of stud bolts,
provided with a heat dissipation through-hole at a middle of the heat dissipation body,
rotatably and thermally connected to a mounting bracket,
provided with at least two lens panels on which the plurality of lenses are fixedly arranged, at least two LEDs being arranged on the PCB board within a coverage range of the lens panel,
provided with a shroud on a light emitting side of the outdoor LED light.

2. The outdoor LED light according to claim 1, wherein a portion of the plurality of needle-shaped heat dissipation columns gradually increase their heights in a radially outward direction from a center of the heat dissipation body, so that an curved surface structure is formed by each end of the portion of the plurality of needle-shaped heat dissipation columns facing away from the heat dissipation body.

3. The outdoor LED light according to claim 2, wherein the power supply compartment is provided, on one surface of the power supply compartment facing the heat dissipation body, with a convex surface protruding toward the heat dissipation body.

4. The outdoor LED light according to claim 2, wherein the other portion of the needle-shaped heat dissipation columns at the edge of the heat dissipation body gradually decrease their heights in a radially inward direction.

5. The outdoor LED light according to claim 1, wherein a diameter of the needle-shaped heat dissipation columns located at an outer periphery of the heat dissipation body is greater than a diameter of the needle-shaped heat dissipation columns located at an inner periphery of the heat dissipation body.

6. The outdoor LED light according to claim 5, wherein the heat dissipation through-hole is internally provided with a through-hole fastener, and the through-hole fastener is provided with an elastic reversed buckle.

7. The outdoor LED light according to claim 1, wherein the stud bolt respectively comprises a cylinder including a middle connecting hole along a length direction of the cylinder, a plurality of first reinforcing ribs extending around the cylinder.

8. The outdoor LED light according to claim 7, wherein the heat dissipation body is provided symmetrically, on the one side of the heat dissipation body facing the power supply compartment, with a pair of handles, which are fixedly arranged on the heat dissipation body through the stud bolt.

9. The outdoor LED light according to claim 8, wherein the mounting bracket is provided with a first axle hole and an arc-shaped chute arranged around the first axle hole; the heat dissipation body is provided with a mounting wall for connecting the mounting bracket, the mounting wall is provided with a second axle hole coaxial with the first axle hole and a threaded hole with an axis passing through the arc-shaped chute; the first axle hole and the second axle hole are connected through a bolt, a bolt passing through the arc-shaped chute is arranged in the threaded hole.

10. The outdoor LED light according to claim 9, wherein a plurality of said threaded holes are arranged evenly on a circumference taking the first axle hole as a center of the circle.

11. The outdoor LED light according to claim 9, wherein the mounting wall is provided, on a back surface of the mounting wall, with a plurality of second reinforcing ribs.

12. The outdoor LED light according to claim 11, wherein the mounting bracket is provided with a plurality of ventilation holes.

13. The outdoor LED light according to claim 1, wherein the at least two lens panels respectively have a fan-shaped structure and circumferentially arranged to form a circular structure.

14. The outdoor LED light according to claim 1, wherein the heat dissipation body is provided with a waterproof concave cavity at a position of the heat dissipation body corresponding to the lens panel, and the lens panel is embedded in the waterproof concave cavity.

15. The outdoor LED light according to claim 14, wherein the lens panel is provided at an edge with a first waterproof groove, and waterproof sealing is formed between the lens panel and the heat dissipation body through a first waterproof ring embedded in the first waterproof groove.

16. The outdoor LED light according to claim 1, wherein the power supply compartment comprises:
a top shell provided with a second waterproof groove and a waterproof retaining edge,
a bottom shell, and
a second waterproof ring arranged between the top shell and the bottom shell, the second waterproof ring comprising an extending portion, and a first bonding portion and a second bonding portion located on both sides of the extending portion,
wherein, during mounting, the extending portion is embedded in the second waterproof groove, the first bonding portion and the second bonding portion are attached to an inner wall of the top shell, and the waterproof retaining edge is respectively attached to a side surface of the second bonding portion and the bottom shell.

17. The outdoor LED light according to claim 1, wherein the power supply compartment is provided, on a side surface and a surface of the power supply compartment facing far away from the heat dissipation body, with a plurality of heat dissipation fins in divergent arrangement.

18. The outdoor LED light according to claim 1, wherein the heat dissipation body is provided with a ring-shape pressing plate, the heat dissipation body is provided on a side surface with a concave shoulder, the ring-shape pressing plate is provided at one end with an inwardly extended supporting wall, the ring-shape pressing plate is sleeved on the heat dissipation body, and the supporting wall is attached to the concave shoulder and is thermally connected to the heat dissipation body.
